(19) United States
(12) Patent Application Publication
(10) Pub. No.: US 2003/0050049 A1
(43) Pub. Date: Mar. 13, 2003

(54) Mobile information service

(76) Inventor: Lars Henrik Sundstrom, Staffanstorp (SE)

Correspondence Address: JENKENS & GILCHRIST, P.C., Suite 3200, 1445 Ross Avenue, Dallas, TX, 75202-2799, US

(21) Appl. No.: 10/114,393

(22) Filed: Apr. 1, 2002

Related U.S. Application Data
(60) Provisional application No. 60/322,373, filed on Sep. 13, 2001.

(51) Int. Cl. H04M 3/42

(52) U.S. Cl. 455/414; 455/426

(57) ABSTRACT

A system and method for providing periodically updated information to a mobile terminal wherein the mobile station is configured to receive via a wireless communications link a periodically updated stream of messages. Each message of the stream of messages includes a mobile internet protocol link. Data contained in the stream of messages is displayed at the mobile terminal outside of a mobile internet protocol browser. The mobile internet protocol link may be actuated in order to display information at the mobile terminal through the mobile internet protocol browser.

### RELATED APPLICATION(S)

This application claims priority from and incorporates herein by reference the entire disclosure of U.S. Provisional Application Serial No. 60/322,373 filed Sep. 13, 2001.

### TECHNICAL FIELD

The present invention relates to the transmission of information to a mobile terminal, and more particularly, a system and method for periodically transmitting information of user interest to a mobile terminal over a messaging infrastructure.

### BACKGROUND OF THE INVENTION

Many current mobile terminal devices such as mobile telephones, personal digital assistants, pagers, laptop computers, etc. are equipped with some type of browser enabling the mobile terminal to wirelessly access the Internet. Through these devices, the users may search for and access various information content stored upon servers connected to the Internet. In addition to providing web browsing capabilities, a number of mobile terminals have access to messaging based services that send information to the mobile terminal using e-mail or short message services (SMS). These messaging based services have a number of problems.

Presently, when users desire to browse for various information content, they are required to open their browser and surf the Internet or access their e-mail or SMS message content to determine if any information has been transmitted to them. Many times it may be difficult for users to see actual value in opening a browser or a messaging service since they are unaware as to what type of information and services they may be able to access. Thus, the user may determine that there is no need to access the browser or message service because no desired information may, in fact, be available.

The man machine interface (MMI) of the mobile terminal also may act as a deterrent for users accessing their browser or messaging service in order to search for or access various information content. A browser or messaging service is normally accessed through a menu or submenu of the MMI navigation system. Statistics have shown that for each required key press, a certain percentage of potential users are lost to accessing particular information content. The user simply does not wish to go to the effort. Thus, if an intensive menu navigation is required in order to search for particular information content, the user may give up or not begin their search due to the level of involvement required of them.

Some solutions to these problems have involved messaging base information services that require a user to access an inbox or respond to a “New Message—Read Now?” prompt. In these situations, active user activity is required in order to access the information. Also, if the user does not access their mobile terminal for a certain period of time, the information may easily become out of date. Some systems, such as GSM, include the cell broadcast functionality which enables information to be sent to all terminals within a GSM network cell. The cell broadcast mechanism is ill-suited for targeting the particular information needs of a specific user and is limited in the amount of information that may be provided to the user.

Therefore, a system and method capable of overcoming the above-described problems in order to easily present users of mobile terminals with various information content while minimizing the activity required on the part of the user to access the content is desired.

### SUMMARY OF THE INVENTION

The present invention overcomes the foregoing and other problems with a method for providing periodically updated information to a mobile terminal. A previously established user profile designates information to be transmitted to the mobile terminal by a periodically updated stream of messages. The periodically updated stream of messages are received at the mobile terminal. Each message of the stream of messages includes a mobile internet protocol link. Data contained within the stream of messages is displayed at the mobile terminal, and the user can actuate a mobile internet protocol link associated with a message in order to access information related to the link. This information is displayed at the mobile terminal through a mobile internet protocol browser.

### BRIEF DESCRIPTION OF THE DRAWINGS

FIG. 1 is an illustration of the operating environment of the system and method of the present invention;

FIG. 2 illustrates the message content transmitted to a subscriber;

FIG. 3 illustrates the manner in which various messages are sequentially presented to a subscriber on their mobile terminal;

FIG. 4 illustrates the manner in which the subscriber may access a message within the mobile terminal;

FIG. 5 illustrates the manner in which the user may access additional information by initiating, for example, a WAP session; and

FIG. 6 is a flow diagram illustrating the method by which mobile information services are provided to a mobile terminal.

### DETAILED DESCRIPTION

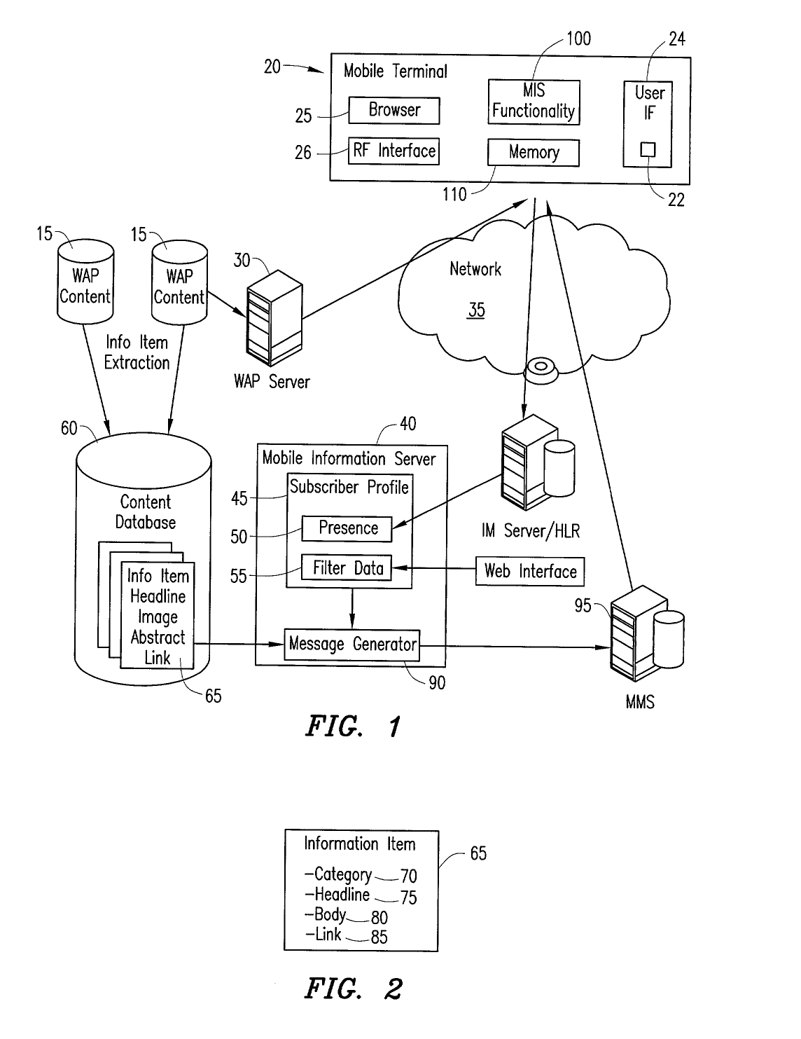

Referring now to the drawings, and more particularly to FIG. 1, there is illustrated the mobile information service (MIS) system of the present invention. While the present invention is described with respect to a system using the wireless application protocol (WAP), it should be realized that the system and method are equally applicable to any other wireless protocols (iMode, etc.) for enabling mobile access to a network such as the Internet. FIG. 1 illustrates a system including a number of WAP content databases 15 (web sites). The WAP content databases 15 include various information items which may be relevant to a particular mobile terminal 20. The WAP content databases 15 provide the data to a mobile terminal 20 in a number of fashions. The user can activate their WAP browser 25 located within their associated mobile terminal 20 and directly access the WAP content 15 via a WAP server 30 through a network 35, such as the Internet. The mobile terminal 20 includes an RF interface 26 enabling connection to the WAP server 30.

Alternatively, according to the present invention, messaging may be periodically provided to the mobile terminal. A mobile information service system server 40 includes a subscriber profile 45 associated with a subscriber's mobile terminal 20. The mobile information service system server 40 contains a plurality of subscriber profiles 45 associated with each separate mobile terminal 20. The subscriber profile 45 includes presence information 50 indicating whether or not a mobile terminal 20 is connected to the system and filter data 55 describing the particular information content in which the subscriber is interested. The mobile information service system server 40 continually transmits an updated stream of information items to the subscriber mobile terminal 20 through mobile messaging server (MMS) 95.

A content database 60, associated with the mobile information service system server 40, includes a number of information items 65 extracted from the WAP content databases 15. Each information item 65, as more fully illustrated in FIG. 2, includes a category 70 describing the category of the information item 65. A list of categories includes, but is not limited to, international news, domestic news, sports, weather, film, and music. A headline 75 provides a short title relating to the subject matter of the information item 65. A body 80 includes a short text description conveying information on the particular information item 65. Finally, a link 85 provides a manner for activating a subscriber's web browser 25 and initiate a WAP session in order to access the data associated with the information item 65 stored at a particular WAP content database 15 via the WAP server 30. The information items 65 are collected by the service provider at the content database 60 responsive to the filter data 55 stored within the subscriber profile 45.

The mobile information service system server 40 further includes a message generator 90 for placing the information items 65 in a proper message format for transmission to the mobile terminal 20 through the mobile messaging server 95. The message generator 90 generates messages for transmission to the mobile terminal 20 at a predetermined interval. In one embodiment, the messages are implemented as an extension to the mobile messaging protocol by adding a special header part containing category, headline, body, length and other parameters. The presence of the header extension signals that the message should be rerouted to the MIS functionality 100 within the subscriber mobile terminal 20.

At the subscriber mobile terminal 20, an incoming message from the mobile messaging server (NMS) 95 is identified as an MIS message by the MIS functionality 100 by identifying the header provided by the MMS 95. The MIS functionality 100 can identify messages in a number of ways. An identification of some type of tab included in the incoming message may be used. The tag may comprise an extension of the SMIL (Synchronized Multimedia Integration Language) syntax of the incoming message. Alternatively, the incoming message may be tagged as a “ticker” (i.e., an information message to be displayed) by using a new message class. The new message class would identify text, audio, image and video parts of an incoming message. The local set of information items 65 stored in the subscriber terminal 20 within a memory 110 is updated with the new information items, and the stored information items are cyclically presented to the user by the MIS functionality 100. The category 70 and headline 75 of each information item 65 are presented sequentially within an idle/standby mode of the subscriber mobile terminal 20 by the MIS functionality 100 without requiring any user interaction. A user can choose to view the body 80 of the message and selectively activate the link 85 to the original WAP content via the WAP server 30.

Referring now to FIGS. 3 through 5, wherein there is more fully illustrated examples of how various information items 65 are presented upon a display to the user of the subscriber mobile terminal 20 by the MIS functionality 100. The display comprises part of the user interface 24. In FIG. 3, there is illustrated the manner in which a number of information items are sequentially displayed. In the first instance, the display of the subscriber mobile terminal 20 shows the category “Sport” and the headline “NHL: Forsberg out”. After a period of three seconds (this may be any interval), the next information item is displayed having the category “Music” and the headline “Disco is back”. After another three second period, the information item having the category “Economy” and the title “Market in decline” is displayed. This process continues for each of the information items 65 stored within the memory 110 of the subscriber mobile terminal 20. When the last information item 65 is displayed, the process returns to the first information item and repeats the entire list again. This information is displayed to the user during the standby/idle mode of the subscriber mobile terminal 20. The user is able to receive an indication of the information being provided by just glancing at the display of the subscriber mobile terminal 20. Thus, no particular input or active action is required by the user.

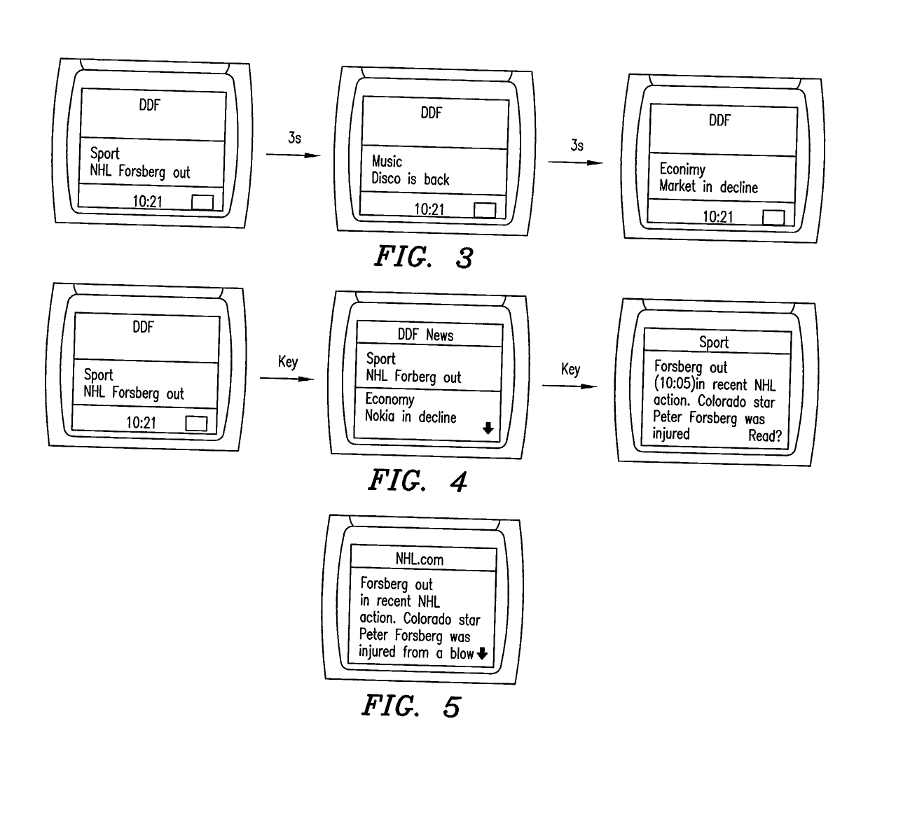

Referring now to FIG. 4, there is illustrated a sequence of displays wherein the user is able to obtain more information on a particular information item 65 by actuating a predetermined key 22 on a user interface 24 (FIG. 1) of the subscriber mobile terminal 20. In the first display, the information item 65 is displayed as the category “Sport” and the headline “NHL: Forsberg out”. By pressing the predetermined key 22 (FIG. 1), the user is able to display various categories 70 and their associated headlines 75. By again pressing the predetermined key, the body 80 associated with a highlighted information item 65 is displayed. In this case, the body 80 provides information relating to Peter Forsberg. Referring now to FIG. 5, by again pressing the predetermined key 22, the link 85 associated with the information item 65 is used to actuate a browser 25 and a WAP session to access the information content (a website) relating to the information item 65 through the WAP server 30.

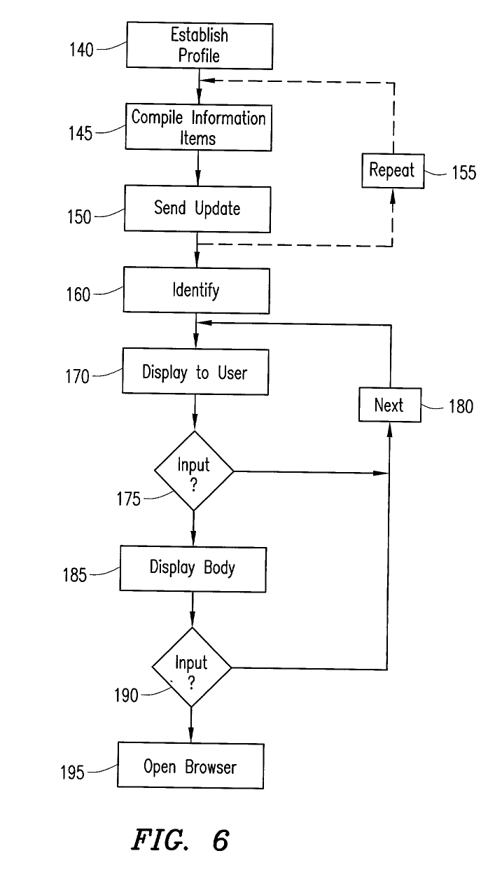

Referring now to FIG. 6, there is illustrated a flow diagram describing the process wherein the mobile terminal is periodically provided information according to the system and method of the present invention. The user must first establish at step 140 a subscriber profile containing the various information the user wishes to have transmitted to them. Responsive to the established subscriber profile, information items are compiled at step 145 on each of the topics indicated in the subscriber profile. The compiled information items are transmitted at step 150 to the subscriber mobile terminal. The process of transmitting information items is repeated at step 155 on a periodic basis for each of the newly received information items compiled at step 145. The received information items are identified at step 160 by the subscriber mobile terminal and sequentially displayed to the user at step 170. Inquiry step 175 monitors for a user input with respect to a displayed item and if none is received, the next information item is retrieved at step 180 and presented to the user at step 170. If an input is detected at step 175, the body of text related to the displayed information item is displayed at step 180. Inquiry step 190 monitors for additional input actuating the link associated with the displayed information. If none is detected, control passes back to step 180, and a next information item category and headline are presented to the user at step 170. If an input to actuate the link is received step 190, the browser is opened at step 195 and a WAP session initiated to the link associated with the information item.

Using the above-described system and method, a subscriber is provided information of interest without having to search for it via their browser. The information is available to the user at a glance since it is displayed within the standby/idle mode of the mobile terminal and does not require the user to enter any particular messaging application in order to obtain the information. The user upon seeing information of interest, may easily initiate a WAP session in order to access information associated with the information item.

The previous description is of a preferred embodiment for implementing the invention, and the scope of the invention should not necessarily be limited by this description. The scope of the present invention is instead defined by the following claims.

What is claimed is:

1. A method for providing periodically updated information to a mobile terminal, comprising the steps of:
receiving a periodically updated stream of messages at the mobile terminal, each message of said stream of messages having a mobile internet protocol link associated therewith;
displaying, outside of a mobile internet protocol browser, data contained within the stream of messages at the mobile terminal;
actuating the mobile internet protocol link associated with a message of said stream of messages to access information related to the mobile internet protocol link; and
displaying the information through the mobile internet protocol browser.

2. The method of claim 1, wherein each message of said stream of messages further includes a headline and a selected amount of text.

3. The method of claim 2, wherein the step of displaying further comprises the step of sequentially displaying the headline from each message of the stream of messages.

4. The method of claim 2, wherein the step of actuating further comprises the steps of displaying, outside of the mobile internet protocol browser, the selected amount of text responsive to selection of the headline.

5. The method of claim 1, wherein the step of displaying data further comprise the step of displaying the data contained within the stream of messages during an idle state of the mobile terminal.

6. The method of claim 1, wherein the step of actuating further includes the step of accessing a mobile internet website associated with the mobile internet protocol link.

7. The method of claim 6, wherein the step of displaying further comprises the step of displaying the mobile internet website through the mobile internet protocol browser.

8. The method of claim 1, further including the steps of:
establishing a user profile associated with the mobile terminal, the user profile designating information to be included in the periodically updated stream of messages; and
compiling the information to be transmitted in the periodically updated stream of messages responsive to the user profile.

9. The method of claim 8, further including the step of generating messages to be included in the stream of messages, said messages including the compiled information.

10. The method of claim 1, further including the step of identifying messages within the periodically updated stream of messages by a unique tag contained within each message of the stream of messages.

11. The method of claim 10, wherein the tag comprises an extension to SMIL syntax.

12. The method of claim 10, wherein the tag comprises a message type identifying content of the received stream of messages.

13. A method for providing periodically updated information to a mobile device, comprising the steps of:
receiving a periodically updated stream of messages at the mobile device based upon a previously generated user profile, each message in said stream of messages including a mobile internet protocol link associated with a mobile internet website, a headline, and a selected amount of text;
displaying, outside of a mobile internet protocol browser of the mobile device, a first headline associated with a message of the stream of messages at the mobile device;
displaying, outside of the mobile internet protocol browser, a first selected amount of text responsive to selection of the first headline associated with the first selected amount of text;
accessing, through the mobile internet protocol browser, a first mobile internet website associated with the first selected amount of text responsive to selection of the mobile internet protocol link associated with the message; and
displaying the mobile internet website through the mobile internet protocol browser.

14. The method of claim 13, wherein each message in said stream of messages further includes a category indicating a general subject matter of each message.

15. The method of claim 13, wherein the step of displaying a first headline further comprises the step of displaying the first headline during an idle state of the mobile terminal.

16. The method of claim 13, further including the steps of:
establishing the user profile, the user profile designating the type of information to be included in the periodically updated stream of messages; and
compiling the information to be transmitted in the periodically updated stream of messages responsive to the user profile.

17. The method of claim 16, further including the step of generating messages to be included in the stream of messages, said messages including the compiled information.

18. The method of claim 13, further including the step of identifying messages within the periodically updated stream of messages by a unique tag contained within each message of the stream of messages.

19. The method of claim 18, wherein the tag comprises an extension to a SMIL syntax.

20. The method of claim 18, wherein the tag comprises a message type identifying content of the received stream of messages.

21. A method for providing periodically updated information to a mobile terminal, comprising the steps of:
establishing a user profile associated with the mobile terminal, the user profile designating information to be included in a periodically updated stream of messages; and
compiling the information to be transmitted in the periodically updated stream of messages responsive to the user profile;
generating messages to be included in the stream of messages, said messages including the compiled information and a mobile internet protocol link associated therewith;
receiving the periodically updated stream of messages at the mobile terminal;
displaying, outside of a mobile internet protocol browser, data contained within the stream of messages at the mobile terminal;
actuating the mobile internet protocol link associated with a message of said stream of messages to access information related to the mobile internet protocol link; and
displaying the information through the mobile internet protocol browser.

22. The method of claim 21, wherein each message of said stream of messages further includes a headline and a selected amount of text.

23. The method of claim 22, wherein the step of displaying data further comprises the step of sequentially displaying the headline from each message of the stream of messages.

24. The method of claim 22, wherein the step of actuating further comprises the step of displaying, outside of the mobile internet protocol browser, the selected amount of text responsive to selection of the headline.

25. The method of claim 21, wherein the step of displaying data further comprises the step of displaying data contained within the stream of messages during an idle state of the mobile terminal.

26. The method of claim 21, wherein the step of actuating further includes the step of accessing a mobile internet website associated with the mobile internet protocol link.

27. The method of claim 21, wherein the step of displaying the information further comprises the step of displaying a mobile internet website through the mobile internet protocol browser.

28. The method of claim 21, wherein the step of generating a message further comprises the step of placing the message in a header transmitted to the mobile terminal.

29. The method of claim 21, wherein the step of compiling further comprises the step of extracting data from a mobile internet protocol website providing the information.

30. The method of claim 21, wherein the mobile internet protocol comprises the Wireless Application Protocol.

31. The method of claim 21, wherein the mobile internet protocol comprises iMode.

32. A mobile terminal, comprising:
an interface for enabling communication via a mobile internet protocol;
a memory for storing messages from a periodic stream of messages;
a mobile information service function configuring to:
receive a periodically updated stream of messages at the mobile terminal via the interface, each message of said stream of messages having a mobile internet protocol link associated therewith;
display, outside of a mobile internet protocol browser, data contained within the stream of messages at the mobile terminal;
actuate the mobile internet protocol link associated with a message of said stream of messages to access information related to the mobile internet protocol link; and
display the information through the mobile internet protocol browser.

33. The mobile terminal of claim 32, wherein each message of said stream of messages further includes a headline and a selected amount of text.

34. The mobile terminal of claim 33, wherein the mobile information service function is further configured to sequentially display the headline from each message of the stream of messages.

35. The mobile terminal of claim 33, wherein the mobile information service function is further configured to display, outside of the mobile internet protocol browser, the selected amount of text responsive to selection of the headline.

36. The mobile terminal of claim 32, wherein the mobile information service function is further configured to display the data contained within the stream of messages during an idle state of the mobile terminal.

37. The mobile terminal of claim 32, wherein the mobile information service function is further configured to access a mobile internet website associated with the mobile internet protocol link.

38. The mobile terminal of claim 37, wherein the mobile information service function is further configured to display the mobile internet website through the mobile internet protocol browser.

39. The mobile terminal of claim 32, wherein the mobile information service function is further configured to identify messages within the periodically updated stream of messages by a unique tag contained within each message of the stream of messages.

40. The mobile terminal of claim 39, wherein the tag comprises an extension to SMiL syntax.

41. The mobile terminal of claim 39, wherein the tag comprises a message type identifying content of the received stream of messages.
